(19) United States
(12) Patent Application Publication
(10) Pub. No.: US 2010/0038104 A1
(43) Pub. Date: Feb. 18, 2010

(54) HAND HELD MACHINE TOOL

(76) Inventors: Otto Baumann, Leinfelden-Echterdingen (DE); Helmut Heinzelmann, Stuttgert (DE); Thomas Bernhardt, Aichtal-Groetzingen (DE); Hardy Schmid, Stuttgart (DE); Tobias Herr, Stuttgart (DE); Willy Braun, Neustetten (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/373,108

(22) PCT Filed: May 11, 2007
(86) PCT No.: PCT/EP07/54579

§ 371 Date: Sep. 16, 2009

(30) Foreign Application Priority Data
Jul. 10, 2006 (DE) 102006031744.0

(51) Int. Cl. B25D 17/24; B23B 45/16

(52) U.S. Cl. 173/162.1

(57) ABSTRACT

The invention relates to a hand-held machine tool for driving a bit which can be accommodated in a tool holder, with a rotary and/or hammer action. The machine tool includes a drive train which has a drive side associated with a drive unit and a driven side associated with the tool holder. According to the invention, the hand-held machine tool has at least one decoupling unit that is used to form a rotationally elastic coupling between the drive side and the driven side.

### PRIOR ART

The invention is based on a hand-held machine tool according to the preamble to claim 1.

Hand-held machine tools for drilling or impact drilling into stone, e.g. rotary hammers, are known. In an “impact drilling” operating mode, force pulses in the form of impacts are transmitted by an impact die from a striker to an insert tool—embodied in the form of a drill bit—of the rotary hammer. The insert tool is driven to rotate by means of driver lugs, for example with a fixed chuck In this case, an insertion end of the insert tool is axially movable. A drill spindle (hammer tube) sets the fixed chuck into rotation by means of a transmission. A drive unit preferably embodied in the form of a universal motor sets the transmission into rotation.

During the actual machining of stone, unpleasant tool vibrations can occur, which are caused by component oscillations and also by rotary impacts of a drill bit cutting edge, which occur particularly during impact drilling of non-homogeneous types of stone such as concrete. There are various known embodiments for counteracting these oscillations, e.g. providing a damping system with rubber elements or springs in the drilling direction, attaching a handle by means of a swivel joint, or decoupling the movement of the handle in relation to a housing.

### ADVANTAGES OF THE INVENTION

The invention is based on a hand-held machine tool for rotary and/or percussive driving of an insert tool that can be accommodated in a tool socket, having a drive train that includes a drive side close to a drive unit and a driven side close to the tool socket.

According to the invention, the hand-held machine tool has at least one decoupling device that is provided for a torsionally elastic coupling between the drive side and the driven side. The drive train, which is usually embodied as completely rigid between its drive side and its driven side, executes a reliable damping of torque shocks by means of the torsionally elastic coupling of the drive side and the driven side. A tool vibration is reduced and a comfort of an operational reliability for a user is improved. It is advantageously possible for the damping of the rotary drive to occur at several points along the drive train. In this case, an individual step can be taken with a single component or also a corresponding damping at two or more points can be provided. The presence of a torsionally elastic coupling advantageously makes drive train less susceptible to wear. In this context, the term “decoupling device” should be understood to mean a device that is situated between two components and is provided to decouple rotary angular momentums between these two components, in particular a damping and/or particularly advantageously, an insulation of rotary impulses between these two components.

Also according to the invention, the decoupling device has at least one torsionally elastic connecting element, which makes it possible to achieve an advantageous torsionally elastic decoupling of Torque shocks between two components that transmit a drive torque to one another. In a particularly advantageous embodiment, the torsionally elastic connecting element is provided with a bushing so that it can achieve a structurally simple torsionally elastic decoupling along the drive train, particularly if the bushing is embodied in the form of a rubber-elastic bushing. It is fundamentally possible to use other torsionally elastic connecting elements deemed useful by those skilled in the art, such as a torsion spring and other different spring elements.

In another embodiment of the invention, the decoupling device has at least one decoupling means that additionally permits a decoupling in the axial direction. This can improve a comfort of the hand-held machine tool for an operator since this advantageously permits a damping of an axial drive motion of the impact mechanism along the drive train, as can be achieved in particular by means of rubber-elastic damping elements.

Advantageously, the decoupling means that permits the decoupling in the axial direction is situated in the region of a hammer tube in the axial direction, thus making it possible to achieve a particularly advantageous damping of axial impulses such as hammering motions. In addition, it is advantageously possible to increase a service life of individual components in that the axial and/or torsionally elastic decoupling means protects them from an increased wear.

An advantageous overload of a torsionally elastic connecting element can be avoided if the hand-held machine tool has at least one corresponding stop surface.

There are various different possible types and/or arrangements of the impact-damping and oscillation-damping coupling. The torsionally elastic connecting element can be advantageously provided for a torsionally elastic accommodation of a fixed chuck. The fixed chuck is situated in the drill spindle. As a result of this, the torque shocks produced by a drilling tool during impact drilling can be advantageously damped in a transmission from the fixed chuck to the drill spindle, particularly if the torsionally elastic connecting element is embodied in the form of a rubber-elastic bushing. In addition to a torsionally elastic decoupling, this can also achieve an additional decoupling in the axial direction between the fixed chuck and the drill spindle.

In addition or alternatively, the torsionally elastic connecting element is situated between the drive unit and a drive pinion so that the drive unit is connected to the drive pinion in an advantageously vibration-damped fashion and a wear in the drive unit and on the drive pinion can be advantageously reduced. It is particularly advantageous for the torsionally elastic connecting element to be connected to the drive unit and/or the drive pinion in a form-locked fashion in order to transmit a drive torque between the drive unit and the drive pinion.

In addition, at least one gear of at least one transmission unit associated with the drive train can be connected to a shaft in a torsionally elastic fashion. The connection can also be embodied of several parts with elastic connecting elements, thus making it possible to achieve a particularly efficient decoupling and/or damping along the drive train.

Another possibility is to provide a spline, which is associated with the drive train, with a torsionally elastic connecting element. Preferably, the spline is situated on an intermediate shaft between the drive unit and a drill spindle. This makes it advantageously possible to reduce a wear on components through a damping and/or decoupling of vibrations and/or torque shocks and simultaneously permits an advantageous transmission of a drive torque, particularly if the torsionally elastic connecting element is situated in a form-locked manner between the intermediate shaft and the spline.

According to another embodiment, an overload coupling with at least one torsionally elastic connecting element is provided; the overload coupling can be advantageously protected from torque shocks and/or pulse shocks of the impact mechanism.

It is also advantageous if the hand-held machine tool has at least one torsionally elastic rotary drive means that is situated inside the tool socket, thus making it possible in particular to provide particularly effective damping of torque shocks of an insert tool as they are transmitted to the tool socket. The expression “torsionally elastic rotary drive means” should be understood to be a means, in particular a groove means, which can be composed of a slot nut as well as a groove and which, for the torsionally elastic decoupling in particular of torque shocks, is embodied as torsionally elastic and/or is supported in a torsionally elastic fashion.

Depending on the hand-held machine tool, its power class, its intended use, and the like, one or more of the steps can be suitably taken.

### DRAWINGS

Other advantages ensue from the following description of the drawings. An exemplary embodiment of the invention is shown in the drawings. The drawings, the description, and the claims contain numerous features in combination. Those skilled in the art will also suitably consider the defining characteristics individually and unite them to form other meaningful combinations.

FIG. 1 shows a longitudinal section through a drive train of a preferred rotary hammer with an impact mechanism arrangement and

FIG. 2 shows a cross section rough a drill spindle along the line II-II in FIG. 1.

### DESCRIPTION OF THE EXEMPLARY EMBODIMENT

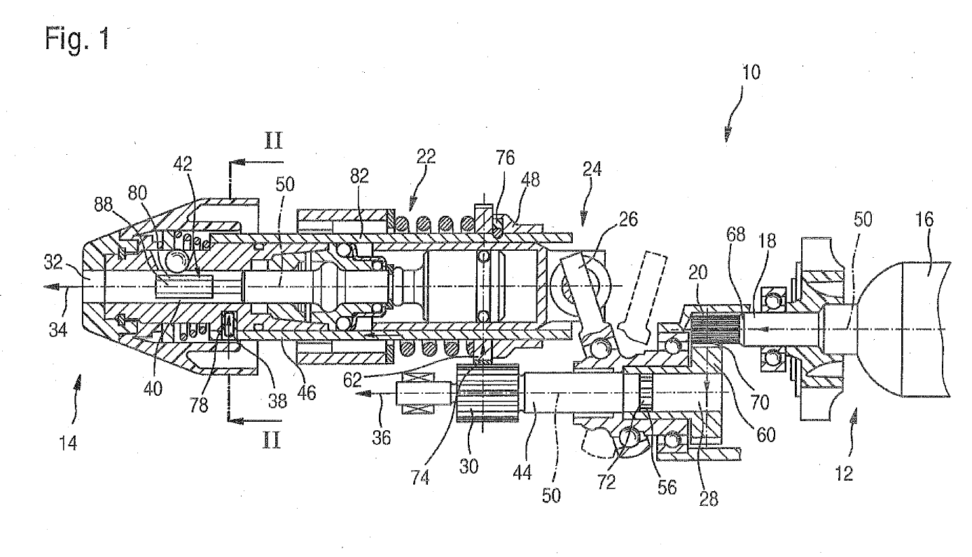

FIG. 1 shows a longitudinal section through a drive train 50 of a preferred hand-held machine tool 10 embodied in the form of a rotary hammer, with an impact mechanism arrangement. The function and design of the drive train 50 of a rotary hammer is generally known to those skilled in the art, obviating the need for a detailed description here.

An insert tool that is not shown in detail can be driven in a rotary and/or percussive fashion when it is inserted into a tool socket 32. The tool socket 32 contains a fixed chuck 40 in which the insert tool can be automatically locked in an intrinsically known fashion upon insertion. The insert tool, which is held in the tool socket 32 in the working state, is connected via the drive train 50 to a drive unit 16 that is preferably embodied in the form of an electric motor and is depicted only in schematic fashion here.

The drive train 50 has a drive side 12 close to the drive unit 16 and a driven side 14 close to the tool socket 32. A shaft 18 of the drive unit 16 transmits a drive torque to a drive pinion 20 that engages with an intermediate shaft 44. Arrows in FIG. 1 indicate the transmission path of the drive torque in the drive train 50 from the drive unit 16 to the insert tool that is not shown. In this case, a gear 60 transmits the drive torque from the drive pinion 20 of the drive unit 16 to the intermediate shaft 44 and an additional gear 62 transmits it from the intermediate shaft 44 to a drill spindle 46. Depending on the position of a first transmission unit 28 and a second transmission unit 30, the insert tool can be driven in rotary fashion, percussive fashion, or rotary and percussive fashion.

For the torsionally elastic decoupling of torque shocks along the drive train 50, the hand-held machine tool 10 has a decoupling device that is situated between the drive side 12 and the driven side 14 of the drive train 50. The decoupling device has various torsionally elastic connecting elements 68, 70, 72, 74, 76, 78, 80 that are situated between two components that transmit a drive torque to each other. The first torsionally elastic connecting element 68 is situated between the drive unit 16 and the drive pinion 20 and reduces a transmission to the drive unit 16 of torque shocks and/or vibrations that occur during a percussion drilling operation of the hand-held machine tool. The torsionally elastic connecting element 68 in this case is connected to the drive unit 16 in a form-locked manner and is connected to the drive pinion 20 in a form-locked manner as well.

The additional torsionally elastic connecting element 70 is situated between the shaft 18, which transmits a drive torque of the drive unit 16, and the gear 60 included in the first transmission unit 28. This advantageously reduces a transmission of torque shocks and/or vibrations from the gear 60 to the shaft 18. The first transmission unit 28 can also be provided with additional torsionally elastic connecting elements between the individual gears in a manner deemed useful by a person skilled in the art so as to achieve a maximum damping of torque shocks and/or vibrations.

Along the intermediate shaft 44, a spline 56 is provided in it, which transmits a drive torque from the intermediate shaft 44 to an impact mechanism 22. The impact mechanism 22 here is embodied in the form of a wobble shaft 44 with a wobble pin 26. The spline 56 disengages the wobble pin 26 or, during use, brings it into an operational connection with the insert tool and the tool socket 32. The impact mechanism 22 transmits pulse shocks to the insert tool in the longitudinal direction 34. The longitudinal direction 34 is parallel to a longitudinal direction 36 of the intermediate shaft 44. The two end positions of the wobble pin 26 are shown in the drawing with a solid lines and dashed lines, respectively. In the exemplary embodiment, the rotary-supported drill spindle 46 is embodied in the form of a hammer tube 82.

For the torsionally elastic decoupling, the spline 56, together with the torsionally elastic connecting element 72, is situated in a form-locked manner on the intermediate shaft 44 so that a maximum decoupling is achieved in a transmission of a drive torque.

At an end oriented toward the tool socket 32, the intermediate shaft 44 is connected to the gear 62 of the second transmission unit 30 by means of the torsionally elastic connecting element 74. The torsionally elastic connecting element 76 is also situated in the region of an overload coupling 48. The torsionally elastic connecting element 76 of the decoupling device is provided for a damping of angular momentum shocks and also for a damping in an axial direction during operation of the hand-held machine tool 10 so that the individual components of the overload clutch 48 are advantageously protected from a hammering motion of the impact mechanism 22. The overload clutch 48 protects the drive train 50 from overload in the event that the insert tool becomes jammed, for example, during operation.

A rotary drive 42 is embodied in the fixed chuck 40 and drives an insert tool to rotate when the latter is inserted. To that end, the insertion end of the insert tool usually has a shape that corresponds to that of the rotary drive 42.

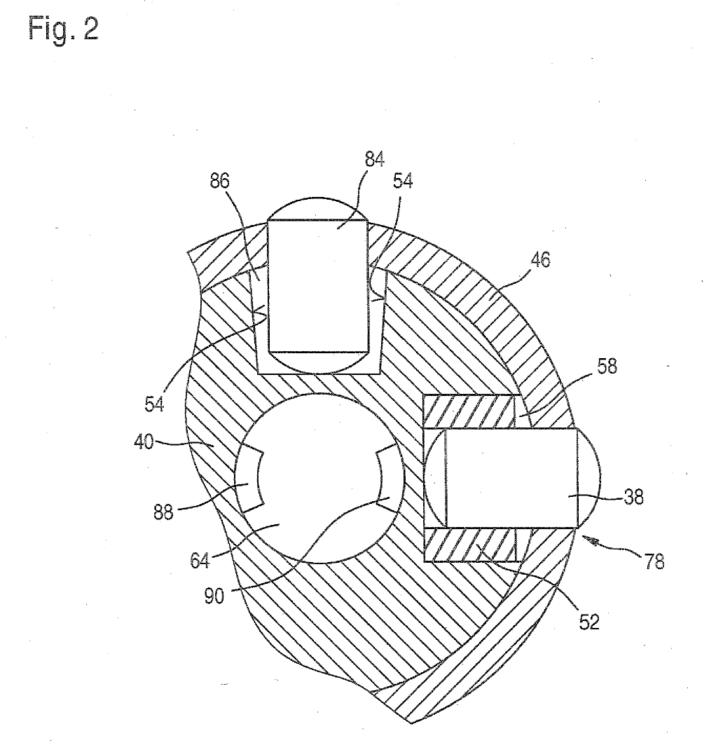

FIG. 2 illustrates a preferred torsionally elastic coupling by showing a partial section along the line II-II in FIG. 1. The rotary-supported fixed chuck 40 is situated in a drill spindle 46 embodied in the form of a hammer tube. The insertion end of the insert tool can be inserted into a central opening 64 of the fixed chuck 40 and locked in position there by means of two inwardly protruding rotary drive means 88, 90. The torsionally elastic coupling is implemented by means of the torsionally elastic connecting element 78 embodied in the form of a rubber-elastic bushing 52, which is situated in a cylindrical recess 58 embodied on the circumference of the fixed chuck 40. The rubber elastic bushing 52 permits a torsionally elastic decoupling of undesirable torque shocks and a decoupling of impulses in an axial direction, constituted by the longitudinal direction 34, in the region of the hammer tube 82. An extension-like, pin-shaped connecting element 38, which is firmly affixed to the drill spindle 46, engages in the recess 58. In order to decouple the fixed chuck 40 from the drill spindle 46 in a torsionally elastic and axial fashion, the connecting element 38 is encompassed by the rubber-elastic bushing 52 inside the fixed chuck 40.

Another extension-like, pin-shaped connecting element 84, which is likewise firmly affixed to the drill spindle 46, is situated in another recess 86. Inside the fixed chuck 40, the connecting element 84 is spaced apart from a cylindrical inner wall of the recess 86. As a result, the inner wall of the recess 86 constitutes a stop surface 54 of the connecting element 84. During operation of the hand-held machine tool 10, when powerful torque shocks occur, the rubber-elastic bushing 52 is protected from overloading because the stop surface 54 limits a vibrating motion of the fixed chuck 40 in relation to the connecting elements 38, 84 and the drill spindle 46.

For further torsionally elastic decoupling, the decoupling device has the additional torsionally elastic connecting element 80 inside the tool socket 32. To this end, the rotary drive means 88, 90 are supported in the fixed chuck by means of the connecting element 80 in the circumference direction to achieve the torsionally elastic decoupling.

1-15. (canceled)

16. A hand-held machine tool for rotary and/or percussive driving of an insert tool, comprising.
a tool socket for accommodating an insert tool;
a drive unit;
a drive train that includes a drive side disposed close to the drive unit and a driven side disposed close to the tool socket; and
at least one decoupling device that provides a torsionally elastic coupling between the drive side and the driven side.

17. The hand-held machine tool as recited in claim 16, wherein the decoupling device has at least one torsionally elastic connecting element.

18. The hand-held machine tool as recited in claim 17, wherein the torsionally elastic connecting element has a bushing.

19. The hand-held machine tool as recited in claim 16, wherein the decoupling device has at least one decoupling means that also permits a decoupling in an axial direction.

20. The hand-held machine tool as recited in claim 17, wherein the decoupling device has at least one decoupling means that also permits a decoupling in an axial direction.

21. The hand-held machine tool as recited in claim 19, wherein the decoupling means that permits a decoupling in the axial direction is situated in the axial direction in a region of a hammer tube.

22. The hand-held machine tool as recited in claim 20, wherein the decoupling means that permits a decoupling in the axial direction is situated in the axial direction in a region of a hammer tube.

23. The hand-held machine tool as recited in claim 16, further comprising means of at least one stop surface for avoiding an overloading of at least one torsionally elastic connecting element.

24. The hand-held machine tool as recited in claim 17, wherein the torsionally elastic connecting element is provided for a torsionally elastic accommodation of a fixed chuck in relation to a drill spindle.

25. The hand-held machine tool as recited in claim 24, wherein the torsionally elastic connecting element is constituted by a rubber-elastic bushing.

26. The hand-held machine tool as recited in claim 17, wherein the torsionally elastic connecting element is situated between the drive unit and a drive pinion.

27. The hand-held machine tool as recited in claim 16, wherein at least one gear of at least one transmission unit associated with the drive train is connected to a shaft in a torsionally elastic fashion.

28. The hand-held machine tool as recited in claim 27, wherein a connection of the at least one gear to the shaft is embodied of several parts with torsionally elastic connecting elements.

29. The hand-held machine tool as recited in claim 16, wherein a spline associated with the drive train is provided with a torsionally elastic connecting element.

30. The hand-held machine tool as recited in claim 29, wherein the spline is situated on an intermediate shaft.

31. The hand-held machine tool as recited in claim 16, wherein an overload coupling is provided with at least one torsionally elastic connecting element.

32. The hand-held machine tool as recited in claim 17, wherein an overload coupling is provided with at least one torsionally elastic connecting element.

33. The hand-held machine tool as recited in claim 16, further comprising at least one torsionally elastic rotary drive means that is situated inside the tool socket.

34. The hand-held machine tool as recited in claim 17, further comprising at least one torsionally elastic rotary drive means that is situated inside the tool socket.
